(19) United States
(12) Patent Application Publication
(10) Pub. No.: US 2005/0175673 A1
(43) Pub. Date: Aug. 11, 2005

(54) Feedstuff for aquatic animals

(75) Inventors: Herbert Kurzinger, Melle (DE); Dietmar Kuhlmann, Stadthagen (DE); Hartmut Schmidt, Georgsmarienhutte (DE)

Correspondence Address: MERCHANT & GOULD PC, P.O. BOX 2903, MINNEAPOLIS, MN, 55402-0903, US

(73) Assignee: TETRA GMBH, Melle (DE)

(21) Appl. No.: 10/509,958

(22) PCT Filed: Apr. 3, 2003
(86) PCT No.: PCT/EP03/03493

(30) Foreign Application Priority Data
Apr. 5, 2002 (DE) 102 15 185.7

(51) Int. Cl. A23K 1/165; A23K 1/17

(52) U.S. Cl. 424/442; 426/645

(57) ABSTRACT

The invention relates to feedstuff for aquatic animals, which contains at least two feed mixes of different composition in single-piece units and which is characterized in that the single-piece units comprise at least two contiguous and merging zones that contain the feed mixes separately from each other. Most preferably, the feedstuff consists of bi- or multicolored feedstuff flakes that contain different feed mixes or drugs in individual separate zones. The invention also relates to a method for producing the feedstuff. The flakes prevent the aquatic animals from selective feeding and allow the simple adjustment of a desired density and speed of descent.

The invention relates to feedstuff for aquatic animals, especially for warm- and cold-water ornamental fish and reptiles in fresh or salt water.

In the keeping of such aquatic animals, problems arise again and again both with respect to a well-balanced, species-appropriate nutrition and with respect to an appropriate treatment with agents for treating or preventing illnesses.

In the care, breeding, and keeping of aquatic animals, diseases that can lead to considerable financial losses occur in hobby aquariums and pools, and to a still greater degree in the management-intensive facilities of fish farms and aquacultures. Fish-pathogenic organisms appearing in this context consist of viruses of the most various species, bacteria, fungi, dinoflagellates, protozoa, helminthes, or fish-parasitic crustaceans.

The treatment of fish illnesses caused by these takes place, on the one hand, through so-called bath therapy, in which the agent is added to the fish tank water in appropriate, biocidic concentrations, and on the other hand, through an oral or enteral administration of an agent (medicinal feed or oral proprietary pharmaceutical) or parenteral application of an agent. This application of an agent has up to now been carried out using special administration forms that are separate from the usual feed offering.

In the feeding of aquatic animals using conventional feedstuffs, it is difficult to satisfy the nutritional requirements of the aquatic animals. A large number of health problems in aquatic animals are to be traced back to poorly-balanced nutrition. Defects of conventional feedstuff mixtures are, for example, unbalanced protein content, lack of essential amino acids, insufficient vitamin content or insufficient mineral content. Such defects increase the susceptibility of fish to illnesses and infections.

Fish feeds are known in the form of flakes, pellets, sticks, or granules that, in each case, consist of one feed type or feed mixtures composed of several feed types as well as, if necessary, medicinal additives. Generally common is fish feed to which vitamins, minerals, fat, etc. are added; this feed can be dyed. As a rule, the formulation contains in concentrated form a large number of vital nutrients, vitamins, and trace elements, which are mixed together with the roughage mixture prior to the final processing into flakes, pellets, sticks, or granules. In the case of flake feed, which can consist of the most varied ingredients and is offered in the greatest variety of flake sizes, the offerings are quite multifarious.

In connection with the feeding, the problem exists that, as a rule, aside from other aquatic animals, in particular fish of several species are kept in common in pools or aquariums, which species can exhibit completely different feeding behaviors. Thus, there are fish that are called bottom-feeders because they take their nourishment in the immediate vicinity of the bottom. Others, on the other hand, ingest the feed directly beneath the surface of the water, and still others search for their nutrition in the region in between. There are fish that disregard feed if it is not offered at the correct water depth. In order to conform to these feeding habits, the floating and sinking behavior of the feed should be adjusted such that it remains as long as possible at the level desired in each case. This is difficult with the conventional “unit feeds and is only partially successful. The disadvantage of this is that feed not ingested sinks to the bottom, clouds the water, and negatively influences the water quality. This is true especially for flake feed that is not ingested, which can cloud the water very severely, so that a change of water becomes necessary and aquariums or fish ponds must be cleaned more frequently.

Further, there exists the problem that the production method for conventional fish feed must be carried out at relatively high temperatures in order to achieve for all the components an adequate homogenization, sterilization, and drying. In this, the quality of the feed suffers greatly when the feed contains heat-sensitive components such as, for example, vitamins. During the heating there also exists the danger that, for example, the vegetable and animal proteins will coagulate and become denatured. Also, water-vapor soluble components may be lost. The individual raw materials thus exhibit different physical and chemical characteristics, from which fact it follows that the raw materials, in order that they not be damaged, must be processed into the end product in an actually separated manner and under conditions adapted to the individual components. If these materials, as is conventional, are subjected in common to a uniform production process, they lose nutrition-physiological value, and sensitive biological agents have still only a very limited effectiveness. In order to compensate for these losses from the start, until now one applied sensitive feed components in very high concentrations. Only in this way did one ensure that at the end of the production process sufficient amounts of nutritionally rich ingredients such as vitamins, proteins, or essential fatty acids were available for the animals.

Since it is therefore difficult to unite all of the nutrients and agents in a single feedstuff, until now one produced different preparations, such as specialized flakes or granules, in separate processes, and then mixed these together in the desired proportion in a further operational step. However, when different feeds come on the market in the form of a mixture, one can observe that the aquatic animals first snatch at certain feed types or visible components, while ignoring others. In other words, practice has shown that, upon appropriate offer, e.g. fish will select their food according to smell, taste, and color. It has also been shown that fish ingest bright, multicolored feed more easily and with substantially fewer problems than single-colored feed. Aside from the fact that in this way the animals do not ingest the feed in the mixture proportions intended by the keeper, in the case of deficient filtering performance there exists the danger that the remaining, non-ingested feed will stay in the water or on the bottom and spoil.

From such a feed selection, which one also calls selective feeding, frequently results malnutrition, with the known health disadvantages for the animals.

Since these problems are known, different feed types are offered in containers with several compartments and must be measured out manually. Here, however, the amount proportions of the components favorable for the animals are often incorrectly measured by the keeper, so that over longer time periods too much nutrition-rich feed or too little of the essential components are administered, which in turn can lead to malnutrition, as for example adiposis or deficiency symptoms and, in the case of delicate animals, even to death.

The invention is thus based on the object of improving the known feedstuffs for aquatic animals, as they are described above, in such a way that the selective feeding, with the described disadvantages, is prevented and suitable, widely-applicable, economical, easily producible, and, on top of everything, optically very attractive (not only for the animals) feed is made available. It is a further object of the invention to make possible a common application of feed and medicine, in particular when the medicine, due to its peculiar taste, is otherwise applicable only with difficulty.

According to the invention, this object is achieved through a feed that, in single-piece units, contains at least two feed mixtures of different composition and is characterized through the fact that the single-piece units consist of at least two contiguous zones or segments that merge into each other, which zones or segments contain the feed mixtures separately from each other. The single-piece units thus display at least a first region and a second region, which border each other.

The object of the invention is thus a feed for aquatic animals that, in single-piece units, contains at least two feed mixtures of different composition and is characterized through the fact that the single-piece units consist of at least two contiguous zones that merge into each other, which zones contain the feed mixtures separately from each other.

A further object of the invention is a method for producing a feedstuff for aquatic animals that is characterized through the fact that at least two feed mixtures having different contents or different colors are converted into feed units that consist of at least two contiguous zones that merge into each other, which zones contain the feed mixtures separately from each other.

With the aid of the new type of feed, aquatic animals can be nourished in a simple manner and, if necessary, be treated at the same time for prevention or treatment of illnesses.

Through the firm connection of the otherwise separated components, the aquatic animals no longer have the possibility of selectively ingesting feed components. If they want to ingest their “favorite feed” recognized through its color or its smell, they must also put up with the connected, lesser-appreciated part, which in its amount and composition, in relation to the first part, is precisely measured according to the requirements of the animal. Through this means, deficiency symptoms and all of the other above-describe disadvantages are reliably avoided in the simplest manner.

The feedstuff according to the invention thus enables an optimal adaptation to the nutritional requirements of the individual aquatic animals. A further advantage consists in the fact that in storage, feed or agent components that are incompatible with each other are in contact at only a minimal area, so that they cannot mutually disturb each other and undesired effects are avoided.

Accordingly, for the individual zones of the feed unit different feed/raw material mixtures are prepared, the production processes of which can be precisely adapted to the chemical and physical characteristics and the stability of the individual components. Thus, the production process for all components can be carried out in the most gentle manner possible. Ingredients essential to life are preserved and a denaturing is avoided. Since a prophylactic overdosing, intended to compensate for the losses to be expected during the production and storage, is unnecessary, a lower amount of raw materials can be used, which makes possible considerable savings, when the fact that fish feed is a bulk product is considered.

The feed units according to the invention are obtained through producing the starting mixtures for the individual zones of a unit in the manner most favorable to and compatible with the ingredients in each case and, for example, preparing these for an extrusion process.

In the simplest case, different and also possible differently-colored feed mixtures are extruded by means of one or several extruders into separate worm passages and further processed in a device that unites the separate strands in the desired manner such that the feed strand emerging through the outlet opening or mixing nozzle contains the feed mixtures of all zones placed one against another, the strand in cross section displaying the zones optically as zones that are separate from one another. The image of such a cross section can, for example, be marbled. The first region, in a circular cross section of the strand, can form a small circle in the center that is surrounded by a concentric ring of the second region. A further possibility is the division of the zones into two half-moon shaped halves of equal size.

Several thin strands can also be combined to form one thick strand. Resulting from this are patterns that appear dotted or checkered. The technology of such multicolored extrudates is already known from the field of food technology. In any case, differently-colored “strands” having several ingredients characterized in terms of color are visually no longer unexceptional, as there are the known multicolored toothpastes.

The strands thus obtained are cut by means of rotating knives according to practice into small discs with a thickness of 0.3 to 3 mm so that, to the extent possible, their diameter is significantly greater than their thickness. Thereby it is ensured that each small disc comes to rest on a flat side. The small discs are then split up by means of a vibration trough such that, like cookies on a baking sheet, they can be guided separately to a roller mill. The distance between the small discs is set such that their edges do not touch even when the small discs pass through the press rollers. When the small discs have passed through the rollers, the diameter of the flakes obtained amounts to approximately 5 to 50 mm, preferably 3 to 10 mm, and the thickness lies in the range of 0.03 to 0.3 mm, and for aquarium fish preferably in the range of 0.07 to 0.15 mm. The wafer diameter is determined by the diameter of the outlet opening of the mixing nozzle; the diameter can increase through expansion after leaving the nozzle. The final size must therefore be determined and adjusted according to the material through a test batch. Through the press process of the roller mill one obtains thin feed flakes, the shape of which largely corresponds to the cross section of the strands, the cross section being, of course, considerably reduced during the rolling out and the thickness, in the end, amounting to only a fraction of the thickness of the small wafers. Thus, from a strand with a circular cross section one also obtains approximately circular feed flakes. With appropriately shaped outlet openings, the cross section of the unified strands and thus the shape of the feed flakes can be varied almost at will.

The feed units can display zones of completely different composition; for example, fat-rich and fat-poor zones can be combined with each other. Thus, in the feed unit is prepared a matrix that makes it possible to provide simultaneously both fat-soluble and fat-insoluble nutrients. Also, through a suitable combination of fat-poor and fat-rich zones in a feed unit, the floating or sinking behavior of feed flakes can be adjusted in order to adapt to the feeding habits of the aquatic animals.

In another embodiment form, the sinking behavior of the feed units is controlled through the selection and combination of appropriate expanded and non-expanded zones, which display different densities. An embodiment form with zones of different specific gravity consists, for example, of a fat-rich core and a protein foam shell in the outer region.

A further embodiment form contains water-soluble substances that, after contact with water, through dissolving impart a certain propulsive force to the water surface, so that the feed becomes especially attractive to the animal through its visible movement.

A further embodiment form displays differently colored zones, where the color-enhancing additives can, for example, be carotinoids, which zones, on the one hand, serve to improve the attractiveness and acceptance of the feed by the aquatic animals, and on the other hand serve to intensify the natural color magnificence of ornamental fish, here specifically the yellow, orange, and red color pigments.

Green-colored zones can, for example, be enriched with plant extracts and plant ingredients or algae, adapted to the specific nutritional habits of aquatic animals.

In order to improve the general condition and the prevention of stress, zones of high concentrations of vitamins can be added.

In order to achieve an enhanced resistance to illnesses, zones can be provided that are enriched with agents that exhibit antimicrobial, antioxidative, and/or immune-stimulating properties. Zones can also be provided that are enriched with agents for treating or prevention of illnesses.

For an improved feed utilization and lower burdening of the water, in individual zones very well-digested raw materials can be used, as for example phosphates of animal origins.

For the production of multicolored feed, based on their inherent coloring or color modification the following feed components are especially suitable:

Carotinoids (red/yellow): paprika oil, bixin, β-carotene, astaxanthin, canthaxatin.

Algae (green): spirulina, wakame algae, and seetang. Carotinoids and algae in an added amount of 1 to 8% by weight result in a usable coloring that can be enhanced or changed in tone through additional dyestuffs.

Especially suitable as natural components are: krill, artemia, gnat larvae, water fleas, plankton, tuna fish oil, and omega-3 fatty acids. These components possess a pleasant yellow-brown inherent coloring that can be used as such or enhanced or changed through other color carriers.

Especially suitable as artificial, but feed-safe color components are: E102, Yellow No. 5, Yellow No. 6, E127, Red No. 3, E132, Blue No. 2. The dyestuffs are preferably added in an amount of 0.1 to 1% by weight.

The feed units, adapted to the size and feeding behavior of the aquatic animals, can be provided in the form of flakes, sticks, granules, pellets, or tablets.

The production of the feed according to the invention in the described flake form is especially advantageous and preferred. However, the invention is not limited to the described extrusion process with subsequent rolling out. It goes without saying that other production methods can also be conceived and technically realized. This includes, for example, the production of granulated feed units, whereby, for example, the granule of a certain feed mixture is at least partially coated with a layer of a second feed mixture. In this case, of course, a multicolored characteristic is difficult to realize. But a feed granule thus produced possesses to a large degree all of the other advantages of the invention, such as the setting of a specific density, the prevention of selective feeding, and the possibility of administering pharmaceuticals to aquatic animals together with an attractive feed. There also exists the possibility of bonding two feed layers to each other as laminates and dividing the finished product into flakes that, for example, display two differently-colored surfaces. This is an unfavorable variant if a close contact of the two feedstuff mixtures is to be avoided during the storage.

The features of the invention presented in the description and the claims can be essential both individually or in any combination for the realization of the invention in its different embodiment forms.

The following example serves to explain the invention:

### EXAMPLE

For reasons of better clarity, the feed zones of the example differ as regards contents only through different dyestuffs, which make visible the division of the end product into zones characterized through color.

Preparation of the Base Formulation:

First, a conventional base formulation suitable for processing in the extruder is created, which formulation contains the common base materials of both feed zones. These materials are typical for a feed for fresh- and saltwater animals and consist of fish products and byproducts, cereals, vegetable protein extracts, yeasts, mollusks, crustaceans, oils, fats, algae, mineral nutrients, lecithin, and antioxidants.

Prepared from these base materials is a feed mixture that can be placed into the extruder.

Preparation of Feed Flakes Having Two Differently-Colored Zones:

The dyestuff for the first zone is Red No. 3 dye.

This is mixed homogeneously into water at room temperature. The “dosing liquid 1” thus produced consists of 2.5% Red No. 3 dye and 97.5% water.

The dyestuff for the second zone is Yellow No. 5 dye. This is mixed into water at room temperature. The “dosing liquid 2” thus produced consists of 6% Yellow No. 5 dye and 94% water. Metered into a double-shaft extruder in the entry region is 50 kg/h of the base formulation. Further, 11.5 kg/h of water is injected into the entry region. Both of these are homogeneously mixed together at a temperature of approximately 100° C. to form a viscous mass. At the end of the double-shaft extruder, the mass is divided into two single-shaft extruders. In one of the single-shaft extruders, “dosing liquid 1” is added at a rate of 1 kg/h. “Dosing liquid 1” is mixed homogeneously into the mass. In the second single-shaft extruder, “dosing liquid 2” is likewise added at a rate of 1 kg/h. Present at the outlets of the single-shaft extruders are, respectively, a red- and a yellow-dyed stream of the mass.

Through guide and distribution channels, the dyed streams of mass are combined in a nozzle plate and distributed to 20 outlet openings or mixer nozzles in such a way that a two-colored strand emerges from each outlet opening, in which strand the colors are separated into two concentric cross-section areas. These strands are cut by a rotating knife into discs of 3 mm diameter and a thickness of 1 mm, fed to a roller mechanism, and rolled out into two-colored flakes having a thickness of 0.1 mm.

1. Feed for aquatic animals that contains, in single-piece units, at least two feed mixtures of different composition, wherein the single-piece units consist of at least two contiguous zones that merge into each other and contain the feed mixtures separately from each other.

2. Feed according to claim 1, wherein the individual zones display different colorations.

3. Feed according to claim 1, wherein at least one zone contains fat-rich feed.

4. Feed according to claim 3, wherein the fat-rich feed contains lipophilic additives.

5. Feed according to claim 1, wherein at least one zone contains fat-poor feed.

6. Feed according to claim 1, wherein regions with water-soluble nutrients and/or agents have a fat matrix.

7. Feed according to claim 1, wherein its floating or sinking behavior is adjusted through a combination of zones of different density.

8. Feed according to claim 7, wherein the density is adjusted through a combination of zones of different fat content.

9. Feed according to claim 7, wherein the density is adjusted through a combination of zones of different expansion.

10. Feed according to claim 1, wherein it contains water-soluble substances that upon dissolving in water impart to the feed a propulsive force.

11. Feed according to claim 1, wherein it displays as a first zone a fat-rich core and as a second zone a protein-foam shell.

12. Feed according to claim 1, wherein the at least one feed zone contains enzymes, probiotics, immunomodulators, vitamins, amino acids, fatty acids, sugar, phospholipids, proteins, antioxidants, and/or plant extracts.

13. Feed according to claim 1, wherein the feed unit is formed as a flake, granule, stick, pellet, or tablet.

14. Method for producing a feedstuff for aquatic animals, comprising converting at least two feed mixtures of different content or different coloration into a feed unit that consists of at least two contiguous zones that merge into each other and contain the feed mixtures separately from each other.

15. (canceled)
